(19) United States
(12) Patent Application Publication
(10) Pub. No.: US 2013/0206946 A1
(43) Pub. Date: Aug. 15, 2013

(54) CEILING MOUNTING PLATE

(71) Applicant: HEPACart, Inc., (US)

(72) Inventor: JEFF PIRNER, OVERLAND PARK, KS (US)

(73) Assignee: HEPACart, Inc., Shawnee, KS (US)

(21) Appl. No.: 13/765,767

(22) Filed: Feb. 13, 2013

Related U.S. Application Data
(60) Provisional application No. 61/598,165, filed on Feb. 13, 2012.

(51) Int. Cl. F16M 13/02

(52) U.S. Cl. CPC F16M 13/02
USPC 248/343; 29/525.01

(57) ABSTRACT

A ceiling mounting plate assembly for mounting a device to a suspended ceiling. A panel member is provided with an opening having flanges with a plurality of fastening openings and is adapted to lie atop a ceiling panel. A mounting adapter is received within the panel member opening and is adapted for variable positioning along the panel member opening for connection of the device to the ceiling.

### RELATED APPLICATIONS

The present U.S. non-provisional patent application is related to and claims priority benefit to an earlier-filed provisional patent application titled CEILING MOUNTING PLATE, Ser. No. 61/598,165, filed Feb. 13, 2012. The identified earlier-filed application is hereby incorporated by reference into the present application as though fully set forth herein.

### FIELD OF THE INVENTION

The present invention relates to the installation and mounting of devices in a suspended ceiling structure.

### BACKGROUND OF THE INVENTION

There exists a need for mounting various devices in an existing suspended ceiling system. Such devices include audio-visual components such as cameras and projectors which can have a substantial weight. Signs also frequently need to be mounted and suspended from a ceiling. Suspended ceilings are typically comprised of a grid system providing a framework for receiving individual ceiling tiles. This type of structure does not provide a robust support from which to suspend equipment or devices of any appreciable weight.

One way in which to suspend devices from the ceiling employs strut channels (i.e., unistrut) placed in the ceiling. A hole is cut into the ceiling tile through which the device can be connected to the strut channel. Other such methods are used, but generally leave an unsightly arrangement in the ceiling. Furthermore, the strut channel, or other anchoring substrate, is inadequate to provide substantial support to the suspended device. The inadequately supported weight of the suspended device, therefore, causes the ceiling to sag at the point of connection.

### SUMMARY OF THE INVENTION

An embodiment of the invention comprises a mounting plate adapted to fit in a tile grid section of a suspended ceiling. The mounting plate comprises a sturdy material, preferably relatively light-weight sheet metal. The mounting plate comprises anchoring points for receiving wiring or straps for suspending the mounting plate from a more substantial structure than the ceiling grid, such as the red iron structural framework over the ceiling grid.

The mounting plate is configured with a central opening having raised flanges configured with apertures for receiving fasteners. A mounting adapter is provided for receiving the device to be suspended from the ceiling. The mounting adapter can comprise a 4 inch square electrical junction box which is provided with a plurality of openings and screw holes for receiving the device for mounting. The central opening is dimensioned to receive the mounting adapter which is fastened to the raised flanges. The raised flanges optimally are provided along a substantial length of the mounting plate to provide adjustability in the placement of the secured device at a particular point along the ceiling tile. The raised flanges permit the mounting adapter to be recessed within the plane of the ceiling tile to provide a flush mounting of the suspended device with the ceiling tile.

The mounting plate is adapted to lie over the ceiling tile where the device is to be mounted. A hole is simply cut into the particular ceiling tile at the place of mounting and the device attaches to the mounting adapter through the hole in the tile. When a 4 inch square electrical junction box is used as the mounting adapter, the plurality of knockout holes provide a great degree of flexibility in how the device can be mounted. A cover plate can be used to conceal the hole in the ceiling tile once the device is mounted.

These and other features of the present invention are described in greater detail below in the section titled DETAILED DESCRIPTION OF THE INVENTION.

### BRIEF DESCRIPTION OF THE DRAWING FIGURES

The present invention is described herein with reference to the following drawing figures, with greater emphasis being placed on clarity rather than scale:

FIG. 1 is a perspective view of an embodiment of the ceiling mounting plate.

FIG. 2 is a view in side elevation of an embodiment of the ceiling mounting plate with the mounting adapter as positioned on a ceiling grid system.

FIG. 3 is a perspective view of another embodiment of the ceiling mounting plate.

FIG. 4 is a perspective view of an embodiment of the ceiling mounting plate with the mounting adapter.

FIG. 5 is a perspective bottom view of an embodiment of the ceiling mounting plate.

### DETAILED DESCRIPTION OF THE INVENTION

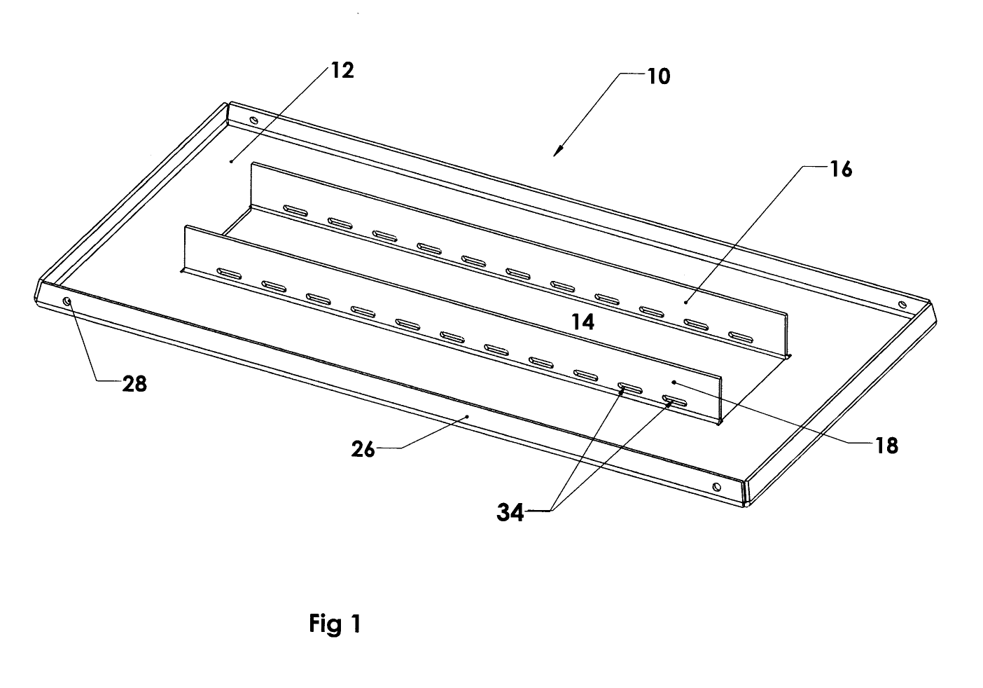

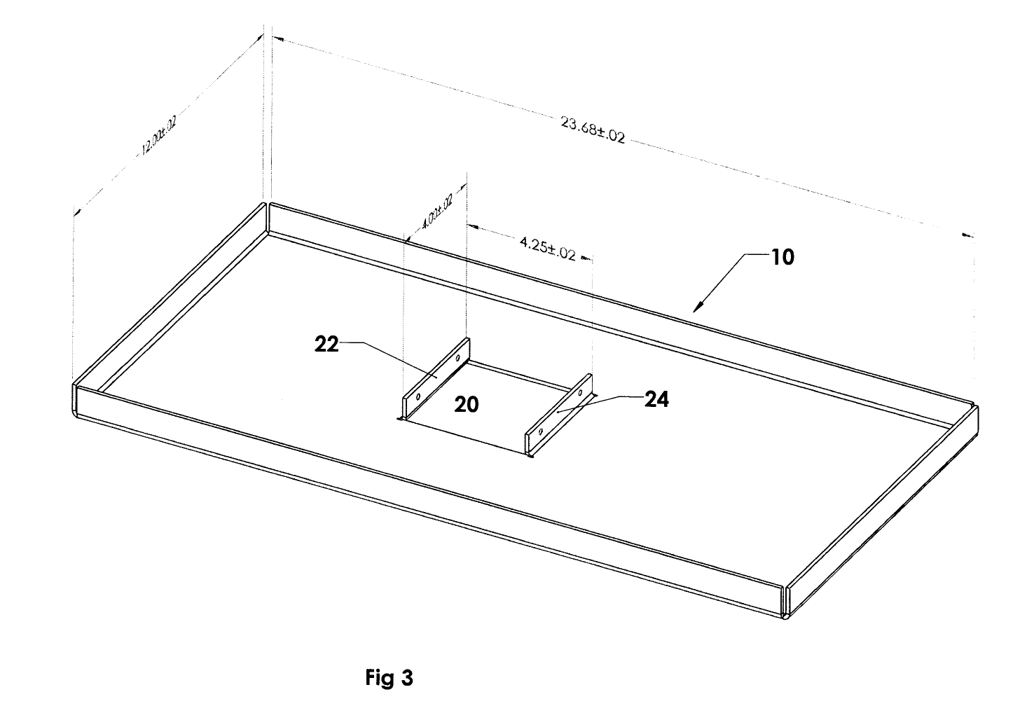

With reference to the drawings figures, a mounting plate for suspending various devices and equipment from a ceiling grid system is herein described, shown, and otherwise disclosed in accordance with various embodiments, including a preferred embodiment, of the present invention. The mounting plate 10 is generally shown in FIG. 1. It comprises a planar sheet 12 which is adapted to lie within a grid section of a conventional ceiling grid system. Mounting plate 10 is preferably comprised of a light-weight sheet metal to provide sufficient rigidity to support the weight of devices to be suspended. Planar sheet 12 is configured to have a central opening 14. Central opening 14 is bordered by raised flanges 16 and 18 which can be formed by cutting, punching and/or bending that portion of planar sheet 12 to form the opening. Flanges 16 and 18 run a substantial distance along the length of planar sheet 12. As seen in FIG. 3, the central opening of mounting plate 10 may alternatively be modified to have a smaller opening 20 with raised flanges 22 and 24 having a shorter length. In this shorter length, the opening may optionally be oriented transversely to the long length of the mounting plate.

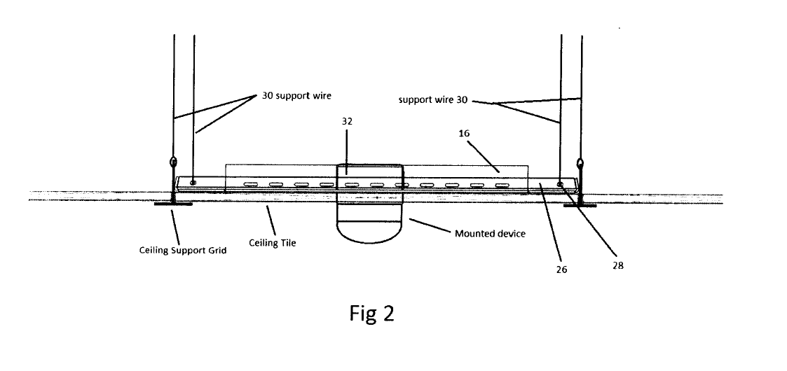

Mounting plate 10 is provided with a perimeter edge flange 26 to provide rigidity to planar sheet 12. A plurality of holes 28 are provided in perimeter edge flange 26 to receive wire or strap supports 30 by which mounting plate 10 may be supported. The grid ceiling system is generally supported from a more permanent structure, such as the overhead red iron structural framework (not shown). The mounting plate 10 may be supported from such structural framework by wire supports 30 as shown in FIG. 2.

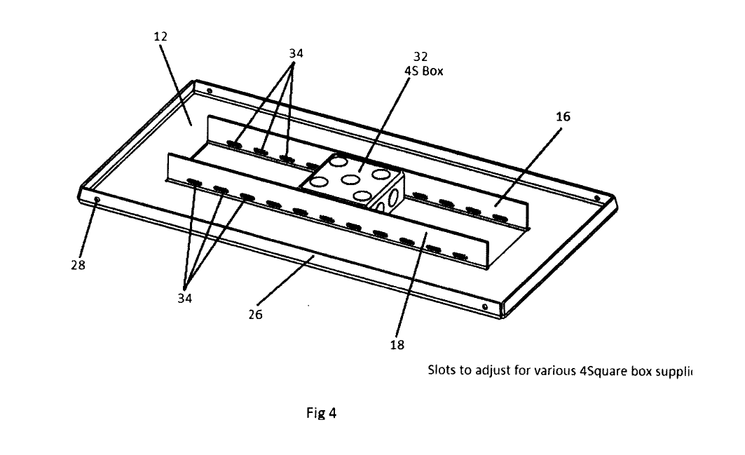

Mounting adapter 32 is shown in FIGS. 2 and 4. It may comprise a standard 4 inch square electrical junction box (4S box), although any structure which provides screw mounting holes to which a device may be fastened and openings for wiring will suffice. The 4S box is optimally suited as a mounting adapter because it has a plurality of knockout holes permitting a variety of fastening arrangements by which a device can be connected and holes for the passage through of wiring. The 4S box also has a standard dimension of 4 inches.

When using a 4S box as mounting adapter 32, as seen in FIGS. 2 and 4, central opening 14 is configured to have a width of slightly greater than 4 inches to receive the mounting adapter 32. Mounting adapter 32 is fastened to flanges 16 and 18 through openings 34. A plurality of openings 34 are provided along flanges 16 and 18 to permit adjustability in the placement of mounting adapter 32 along central opening 14. Openings 34 can be elongated (slot-shaped) as shown in FIG. 1 to provide further adjustability in positioning of mounting adapter when fastening to flanges 16 and 18. Although not shown in the drawings, slot-shaped openings may also be provided in flanges 16 and 18 that run vertically so that a mounted device and be adjusted positionally to have a slight recess within the ceiling.

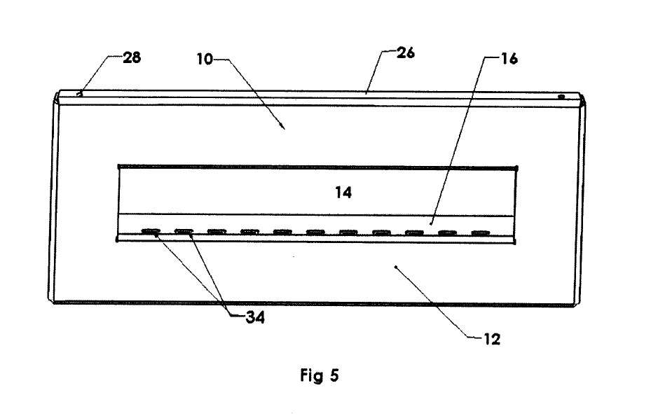

Mounting plate 10 is designed to lie on top of a ceiling tile as shown in FIG. 2. A hole is cut in the ceiling tile at the area in the ceiling where a device or piece of equipment is to be mounted. The flat profile of the bottom of mounting plate 10 (see FIG. 5) permits a flush mounting with the ceiling of a suspended piece of equipment and provides a cosmetically appealing means of connection such that the ceiling tile at the point of attachment appears relatively undisturbed (see FIG. 2). A cover plate may be used around the area of the mounted device to conceal the cut away areas of the ceiling tile.

Although the invention has been disclosed with reference to various particular embodiments, it is understood that equivalents may be employed and substitutions made herein without departing from the scope of the invention as recited in the claims.

Having thus described the preferred embodiment of the invention, what is claimed as new and desired to be protected by Letters Patent includes the following:

1. A ceiling mounting plate assembly for mounting devices in a suspended ceiling, the mounting plate assembly comprising:
a) a flat panel member, and
b) a mounting adapter,
the panel member being adapted for placement on a ceiling tile in a grid ceiling system, the panel member defining an opening with flanges being disposed along opposing sides of the opening, the flanges defining a plurality of fastener openings, the mounting adapter comprising a member having a plurality of fastener openings, the mounting adapter having a dimension to enable it to be received in the opening of the panel member, the plurality of fastener openings in the flanges of the panel member and the fastener openings in the mounting adapter enabling variable alignment of the respective fastener openings for placement of the adapter at variable locations along the panel member, whereby the mounting plate assembly is adapted to receive a device to be mounted to the fastener openings of the mounting adapter at a position on the suspended ceiling.

2. The ceiling mounting plate assembly of claim 1 in which the fastener openings in the flanges comprise an elongated slot to permit adjustment to a point at which the respective fasteners align whereby the location of the placement of the adapter is adjustable.

3. The ceiling mounting plate assembly of claim 2 in which the elongated slots forming the fastener openings in the flanges are oriented perpendicularly with the panel member whereby the mounting adapter is adjustable perpendicularly with respect to the panel member, whereby a mounted device is adapted for a recessed mounting within the mounting plate assembly.

4. The ceiling mounting plate assembly of claim 1 in which the panel member comprises flanged outer edges, the outer flanged edges having anchor points for receiving support members adapted for suspending the panel member from a ceiling structure.

5. The ceiling mounting plate assembly of claim 1 in which the mounting adapter comprises a rectangular housing with a plurality of fastener openings.

6. A ceiling mounting plate for mounting devices in a suspended ceiling, the mounting plate comprising a flat panel member adapted for placement on a ceiling tile in a grid ceiling system, the panel member defining an opening, flanges being disposed along opposing sides of the opening, the flanges defining a plurality of fastener openings, whereby the mounting plate is adapted to receive a device to be mounted to the fastener openings at a position on the suspended ceiling.

7. The ceiling mounting plate of claim 6 in which the fastener openings in the flanges comprise an elongated slot to permit adjustment to a point at which the location of the mounted device is placed.

8. The ceiling mounting plate of claim 7 in which the elongated slots forming the fastener openings in the flanges are oriented perpendicularly with the panel member whereby the mounted device is adapted for a recessed mounting within the mounting plate.

9. The ceiling mounting plate of claim 6 in which the panel member comprises flanged outer edges, the outer flanged edges having anchor points for receiving support members adapted for suspending the panel member from a ceiling structure.

10. A method for mounting a device to a suspended ceiling of the type comprising a grid system of individual ceiling tiles, the method comprising the steps of:
a) preparing an opening in a ceiling tile at an area for mounting the device,
b) providing a mounting plate assembly comprising a flat panel member and a mounting adapter, the panel member having an opening with flanges disposed along opposing sides of the opening, the flanges having a plurality of fastener openings, the mounting adapter having a plurality of fastener openings, the mounting adapter being receivable within the panel member opening,
c) placing the panel member on top of the ceiling panel having the prepared opening,
d) fastening the mounting adapter to the flanges at the panel member opening,
e) fastening the device to the mounting adapter, and
f) mounting a cover plate at the area of the mounting of the device to conceal the cut away portion of the ceiling tile.

11. The method according to claim 10 in which the fastener openings in the flanges comprise an elongated slot, the method comprising a further step of adjusting the position of the mounted device by adjusting the alignment of the point at which the respective fasteners of the flanges openings and the mounting adapter align.

12. The method according to claim 11 in which the elongated slots forming the fastener openings in the flanges are oriented perpendicularly with the panel member, the method comprising a further step of mounting the device in a recessed position within the ceiling.

13. The method according to claim 10 in which the panel member comprises flanged outer edges having anchor points, the method comprising a further step of suspending the panel member from a ceiling structure for additional support.
